(19) United States
(12) Patent Application Publication
(10) Pub. No.: US 2004/0146227 A1
(43) Pub. Date: Jul. 29, 2004

(54) Slide bearing for a roll in a paper/board or finishing machine, and method for making the same

(75) Inventor: Jukka Heikkinen, Jyvaskyla (FI)

Correspondence Address: STEINBERG & RASKIN, P.C., 1140 AVENUE OF THE AMERICAS, 15th FLOOR, NEW YORK, NY, 10036-5803, US

(73) Assignee: METSO PAPER, INC.

(21) Appl. No.: 10/140,688

(22) Filed: May 8, 2002

(30) Foreign Application Priority Data
May 9, 2001 (FI) 20010969

(51) Int. Cl. F16C 17/00

(52) U.S. Cl. 384/7

(57) ABSTRACT

The invention relates to a slide bearing for a stationary or rotary shaft roll (1, 1′) in a paper/board or finishing machine, and a method for manufacturing a slide bearing for such a roll, said bearing comprising a number of bearing elements provided with hydraulically loadableloading shoes (2, 2′), which are mounted either on a stationary shaft (3) of the stationary shaft roll (1) for supporting a roll shell (4) rotatably and for loading the same hydraulically, or around a rotating shaft (5) of the rotary shaft roll (1′) for supporting the shaft (5) rotatably relative to a bearing block (6) or the like. The inventive bearing is constructed as a composite structure, wherein the loading shoe (2, 2′) has its body made from a metal material with a modulus of elasticity higher than that of bronze, and the loading shoe (2, 2′) and/or the rotating shaft (5) of the rotary shaft roll (1′) and/or the shell (4) of the roll (1) with the stationary shaft (3) has its sliding surface (7, 8, 9, 10) coated with a metal material having a lubricating component which prevents seizing in a boundary lubrication situation.

### FIELD OF THE INVENTION

The invention relates to a slide bearing for a stationary or rotary shaft roll in a paper/board or finishing machine, and a method for manufacturing a slide bearing for such a roll, said bearing comprising a number of bearing elements provided with hydraulically loadableloading shoes, which are mounted either on a stationary shaft of the stationary shaft roll for supporting a roll shell rotatably and for loading the same hydraulically, or around a rotating shaft of the rotary shaft roll for supporting the shaft rotatably relative to a bearing block or the like.

### BACKGROUND OF THE INVENTION

In currently available roll-mounted slide bearings, the loading shoes are made from a cast body of bronze. The use of bronze loading shoes stems from an effort to ensure sufficiently good sliding properties between a roll shaft and a loading shoe, even in the event of an oil film normally present therebetween being lost for some reason or another. This is based on bronze having inherently good sliding characteristics, especially when using copper lead or lead bronze. However, a drawback of bronze is its low modulus of elasticity and bearing deformations resulting therefrom, which limit the load capacity of a bearing. Limited load tolerance has become a problem in bearing applications, as increased speeds in modern large and high-speed paper machines necessitate higher loading pressures. In addition, the casting and machining of a lead-bearing metal alloy involve industrial toxicological drawbacks for working conditions and environment.

### OBJECTS AND SUMMARY OF THE INVENTION

It is an object of the invention to provide a novel type of slide bearing for a roll in a paper, board or finishing machine, and a method for making the same.

A bearing of the invention is characterized in that the bearing comprises a composite structure, wherein the loading shoe has its body made from a metal material with a modulus of elasticity higher than that of bronze, and the loading shoe and/or the rotating shaft of the rotary shaft roll and/or the shell of the stationary shaft roll has its sliding surface coated with a metal material having a lubricating component which prevents seizing in a boundary lubrication situation.

A method of the invention is characterized in that the bearing is constructed as a composite structure, wherein a body of the loading shoe is made from a metal material with a modulus of elasticity higher than that of bronze, and a sliding surface of the loading shoe and/or the rotating shaft of the rotary shaft roll and/or the shell of the stationary shaft roll is coated with a metal material having a lubricating component which prevents seizing in a boundary lubrication situation.

Use of the inventive solution provides a roll-mounted slide bearing which is essentially improved in terms of its strength and rigidity. At the same time, the invention also enables the use of higher loading pressures between the loading shoe of a slide bearing and the shell or shaft of a roll. This also enables the use of smaller-than-before loading shoes.

The employed coating material may preferably be for example bronze or the coating may be made by using powder metallurgy.

The applied coating method is preferably molten metal spraying or an HIP process.

### BRIEF DESCRIPTION OF THE DRAWINGS

The invention will now be described in more detail with reference to the accompanying drawings, in which:

FIG. 1 shows in a schematic representation a deflection compensated roll, wherein a shell is supported rotatably on a stationary shaft through the intermediary of slide elements.

FIG. 2 shows in a schematic representation a slide bearing assembly for the end of a roll as shown in FIG. 1, wherein a slide bearing surface is established between the inner shell surface and the loading shoe.

FIG. 3 shows in a schematic representation a slide bearing assembly for the end of a rotary shaft roll, wherein a slide bearing surface is established between the shaft neck and the loading shoe.

### DETAILED DESCRIPTION OF THE DRAWINGS

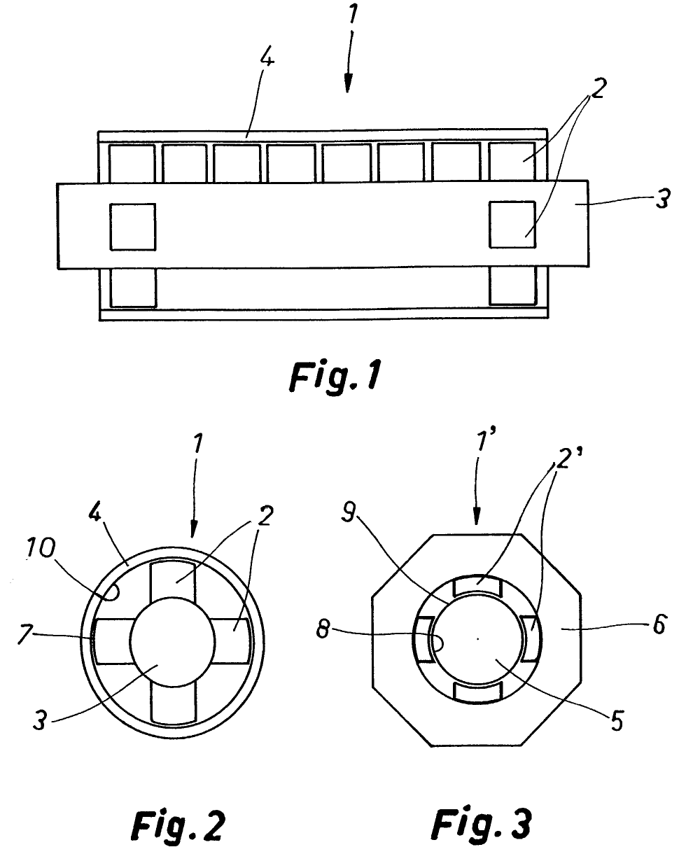

The illustrated slide bearing for a stationary or rotary shaft roll 1, 1′ in a paper/board or finishing machine comprises a number of bearing elements provided with hydraulically loadableloading shoes 2, 2′. The bearing elements are mounted either on a stationary shaft 3 of the stationary shaft roll 1 (FIGS. 1 and 2) for supporting a roll shell 4 rotatably and for loading the same hydraulically, or around a rotating shaft 5 of the rotary shaft roll 1′ (FIG. 3) for supporting the shaft 5 rotatably relative to a bearing block 6 or the like.

Each loading shoe has usually 4 or 6 lubricating pockets into which lubricating oil is fed through the shoe. Around the pockets there are necks which form the sliding surface.

This type of solutions are known as such and, hence, not discussed further at this time.

Normally the oil layer between the sliding surfaces of a shoe and a roll shell is 0.05 mm thick. Owing to some disturbances or deflections of the shoe or the roll shell, however, thickness of the oil layer will decrease or disappear totally which will cause mechanical contact between the sliding surfaces. During fault situations surface pressure may for example be about 30-36 MPa. In such a boundary lubrication situation, when the oil layer is deficient, a risk exists that the sliding surfaces will seize.

According to prior art, the loading shoes 2 are generally made from a cast body of bronze. Such a structure does not provide an all-round satisfactory end result.

Therefore, one of the objects of the invention is to accomplish an improved structure for the slide bearing compared with a cast body of bronze.

In the inventive solution, the bearing is constructed as a composite structure. Thus, the loading shoe 2, 2′ has its body made from a metal material with a modulus of elasticity higher than that of bronze. In addition, the loading shoe 2, 2′ and/or the rotating shaft 5 of the rotary shaft roll 1′ and/or the shell 4 of the roll 1 with the stationary shaft 3 has its sliding surface 7, 8, 9, 10 coated with a metal material having a lubricating component which prevents seizing in a boundary lubrication situation.

In the context of this application, the term “coating” refers to a material layer provided on the sliding surface of a loading element, which is laid on the surface of a cast shoe in a separate coating process. In order to fulfil the requirements of a bearing application, the coating must be an integral part of a body, with no distinctive interfacial surface developing between the body and the coating.

A preferred coating method is for example molten metal spraying (OSPRAY), particularly when coating an external shaft surface, as it is highly suitable for rotationally symmetrical bodies. Another preferred method is powder metallurgy, e.g. an HIP (high isostatic pressing) technique, which is applicable for coating both a shaft and an internal shell surface, and especially the sliding surface of a shoe. In HIP technique, the steel body of a shoe is supplied with a coating material, e.g. pre-alloyed steel, in the form of atomized spherical particles having a very small diameter (<500 μm). The coating material is encapsulated between the steel body and the mould, and the capsule is evacuated. Under a high pressure and temperature, with the coating material nevertheless in a non-molten state, the result is a surface layer having a highly homogeneous and fine-grained constitution, which is also homogeneous in terms of its characteristics and optimizable for each requirement by means of an alloying process. The result is a structure in which the coating is an integral element of the body material, such that delamination cannot take place. The use of bronze as an HIP coating material provides a final result which is particularly optimal in terms of sliding characteristics.

Conventional coating, e.g. by thermal spraying, is also feasible, though not preferred. A thermally sprayed coating is susceptible to delamination, cracking and other such peeling under the slide bearing conditions of a paper machine, particularly if the oil film between sliding surfaces becomes excessively thin and the surface is exposed to contact with a metal. The crumbling of a coating material would be not only fatal in terms of the function of a bearing surface but also inconvenient in terms of the upgrading of circulating lubrication oil. As a matter of fact, thermal spraying as a coating technique is only relevant in exceptional circumstances, in which the bearing shall not be exposed to a major load, and a sufficient oil film can be secured.

The metal material with a higher modulus of elasticity useful as a body material for the shoe in the invention comprises preferably steel (modulus of elasticity in the order of 200 kN/mm2). Other material options may also be feasible. The employed coating material can be e.g. bronze (modulus of elasticity 100 kN/mm2) or e.g. Sn-, Pb-, Mo-alloyed steels with sufficient sliding characteristics.

In preliminary tests tin bronze (CuPb5Sn5) coating accomplished for example with HIP process on steel body has been found as a practical solution.

The inventive solution is capable of providing a structure, which combines a modulus of elasticity sufficient regarding deformations of the shoe and good sliding properties for the bearing. The inventive solution is capable of eliminating the heavy-duty machining of bronze bodies, which is a distinctive improvement in working conditions, especially with regard to lead bronze.

1. A slide bearing for a stationary or rotary shaft roll (1, 1′) in a paper/board or finishing machine, said bearing comprising:
a number of bearing elements provided with hydraulically loadableloading shoes (2, 2′), which are mounted either on a stationary shaft (3) of the stationary shaft roll (1) for supporting a roll shell (4) rotatably and for loading the same hydraulically, or around a rotating shaft (5) of the rotary shaft roll (1′) for supporting the shaft (5) rotatably relative to a bearing block (6) or the like, wherein the bearing comprises a composite structure, wherein the loading shoe (2, 2′) has its body made from a metal material with a modulus of elasticity higher than that of bronze, and the loading shoe (2, 2′) and/or the rotating shaft (5) of the rotary shaft roll (1′) and/or the shell (4) of the roll (1) with the stationary shaft (3) has its sliding surface (7, 8, 9, 10) coated with a metal material having a lubricating component which prevents seizing in a boundary lubrication situation.

2. A bearing as set forth in claim 1, wherein the loading shoe (2, 2′) has its body made from steel.

3. A bearing as set forth in claim 1, wherein the sliding surface (7, 8, 9, 10) is coated with bronze.

4. A bearing as set forth in claim 1, wherein the sliding surface (7, 8, 9, 10) has been manufactured by using powder metallurgy.

5. A method for manufacturing a slide bearing for a stationary or rotary shaft roll (1, 1′) in a paper/board or finishing machine, said bearing comprising a number of bearing elements provided with hydraulically loadableloading shoes (2, 2′), which are mounted either on a stationary shaft (3) of the stationary shaft roll (1) for supporting a roll shell (4) rotatably and for loading the same hydraulically, or around a rotating shaft (5) of the rotary shaft roll (1) for supporting the shaft (5) rotatably relative to a bearing block (6) or the like, said method comprising the steps:
constructing the bearing as a composite structure, wherein a body of the loading shoe (2, 2′) is made from a metal material with a modulus of elasticity higher than that of bronze, and a sliding surface (7, 8, 9, 10) of the loading shoe (2, 2′) and/or the rotating shaft (5) of the rotary shaft roll (1′) and/or the shell (4) of the roll (1) with the stationary shaft (3) is coated with a metal material having a lubricating component which prevents seizing in a boundary lubrication situation.

6. A bearing as set forth in claim 5, wherein the employed coating method is molten metal spraying.

7. A bearing as set forth in claim 5, wherein the employed coating method is an HIP (high isostatic pressing) process.

8. A bearing as set forth in claim 1, wherein the body and coating are formed as an integral structure.

9. A bearing as set forth in claim 1, wherein the sliding surface is coated with alloyed steel comprising at least one alloying element selected from the group: Sn, Pb and Mo.

10. A method as set forth in claim 5, wherein the body and the coating are formed as an integral structure.
